(19) United States
(12) Patent Application Publication
(10) Pub. No.: US 2011/0284728 A1
(43) Pub. Date: Nov. 24, 2011

(54) IMAGING SYSTEMS INCLUDING LOW PHOTON COUNT OPTICAL RECEIVER

(75) Inventors: Geoffrey L. Burdge, Merritt Island, FL (US); Gus W. Deibner, Melbourne, FL (US)

(73) Assignee: Harris Corporation

(21) Appl. No.: 12/781,941

(22) Filed: May 18, 2010

(51) Int. Cl. H01J 3/14

(52) U.S. Cl. 250/216

(57) ABSTRACT

An imaging system (300) is provided. The system includes a second harmonic generator (308) for receiving a source photon beam of a first wavelength and generating a sensor photon beam of the first wavelength and a pump photon beam of a second wavelength that is one half of the first wavelength. The system also includes an amplifier (202) for receiving a signal photon beam and the pump photon beams and producing an amplified photon beam of the first wavelength, where a number of photons in the amplified photon beam being greater a number of photons in the signal photon beam and the signal photon beam includes a portion of the sensor photon beam reflected from a target (318). The system further includes at least one photon counter (204) configured to receive and detect at least a portion of the photons in the amplified photon beam.

### FIELD OF THE INVENTION

The present invention relates to imaging systems, and more specifically to imaging systems including low photon count optical receivers.

### BACKGROUND

In general, the ability to resolve between objects using an optical sensor is principally limited by the Rayleigh criterion. That is, an optical imaging process is said to be diffraction-limited when the first diffraction minimum of the image of one source point coincides with the maximum of another. As a result, the Rayleigh criterion imposes a minimum spacing between two points of 1.22λ/D radians in order to optically resolve the two points, where λ is the wavelength of light being observed and D is the effective size of aperture of the optics being used. As a result, when a particular wavelength and set of optics are selected for an imaging system, the actual resolution of the images will be limited by the Rayleigh criterion, regardless of the capabilities of the detector device or medium being used. Accordingly, high resolution imagery is still generally limited to devices incorporating relatively large optical elements in order to provide a large lens aperture.

### SUMMARY

Embodiments of the present invention concern systems and methods for imaging using low photon count optical receivers. In a first embodiment of the invention, an imaging system is provided. The system includes a second harmonic generator for receiving a source photon beam of a first wavelength. The second harmonic generator generates a sensor photon beam of the first wavelength and a pump photon beam of a second wavelength that is one half of the first wavelength. The system also includes an amplifier for receiving a signal photon beam and the pump photon beams and producing an amplified photon beam of the first wavelength. In the system, a number of photons in the amplified photon beam is greater than a number of photons in the signal photon beam. Further, the signal photon beam includes a portion of the sensor photon beam reflected from an object. The object can be a hard target or a soft target. The hard target can include, but is not limited to, a truck, a plane and a tree as used with a Laser Detection and Ranging (LADAR) system. The soft target can include, but is not limited to, an aerosol, a suspended chemical and a cloud as interrogated by a Light Detection and Ranging (LIDAR) system. The system includes at least one photon counter configured to receive and detect at least a portion of the photons in the amplified photon beam.

In a second embodiment of the invention, an optical receiver is provided. The receiver includes at least one phase modulator for receiving a pump photon beam of a first wavelength. The phase modulator is configured to adjust a phase of the pump photon beam to substantially match a phase of a signal photon beam of a second wavelength that is twice the first wavelength. The receiver also includes at least one beam combiner element for generating a combined photon beam using the pump photon beam from the phase modulator and the signal photon beam. The receiver further includes an amplifier for producing an amplified photon beam of the second wavelength based on the combined photon beam. A number of photons in the amplified photon beam is greater than a number of photons in the signal photon beam. The receiver additionally includes at least one photon counter configured to receive and detect at least a portion of the photons in the amplified photon beam.

In a third embodiment of the invention, an imaging method is provided. The method includes the step of providing a source photon beam of a first wavelength to a second harmonic generator. The second harmonic generator generates a sensor photon beam of the first wavelength and a pump photon beam of a second wavelength. The second wavelength is one half of the first wavelength. The method also includes the steps of directing the sensor photon beam towards at least one object and collecting a signal photon beam. The signal photon beam includes at least a portion of the sensor photon beam reflected by the object. The method further includes the step of generating an amplified photon beam of the first wavelength using an amplifier, the pump photon beam, and the signal photon beam, where a number of photons in the amplified photon beam are greater than a number of photons in the signal photon beam. The method also includes the step of detecting at least a portion of the photons in the amplified photon beam using at least one photon counter to form at least one image.

### BRIEF DESCRIPTION OF THE DRAWINGS

FIG. 1 is a conceptual schematic of an imaging system configured in accordance with an embodiment of the invention.

FIG. 2 is a schematic block diagram of an exemplary optical receiver, according to an embodiment of the invention.

FIG. 3 is a schematic diagram of a LIDAR/LADAR system configured in accordance with an embodiment of the invention.

FIG. 4A is an image representing the result of capturing an image of a scene using an imaging system including detectors modeled as having 100% quantum efficiency.

FIG. 4B is an image of a simulated result of capturing an image of the scene in FIG. 4A using an imaging system including detectors modeled as having less than 100% quantum efficiency.

FIG. 4C is an image of a simulated result of capturing an image of the scene in FIG. 4A using an imaging system including detectors modeled as having less than 100% quantum efficiency, but also including an amplifier in accordance with an embodiment of the invention.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

As described above, the actual resolution of an optical image is principally limited by the lens resolution defined by the Rayleigh criterion. In general, the practical effect of the Rayleigh criterion is that reducing the size of the aperture in an imaging system reduces the number of photons that reach the photon detector device or medium in the imaging system. Consequently, the reduction in the number of photons impairs the ability to discern between two objects.

However, the Rayleigh criterion describes behavior that occurs when using an ideal imaging system. That is, the Rayleigh criterion assumes that all the photons that pass through the aperture are detected by the detector device or medium of the imaging system. However, practical imaging systems behave non-ideally, resulting in the loss of one or more photons received by the imaging system. As a result, the ability to resolve objects is further limited due to non-ideal behaviors of the optical elements, the detector device or medium, or both. For example, the Rayleigh criterion assumes that the optics are ideal and that all photons passing through the aperture are correctly focused on the detector device or medium being used. In practice, some photons will be diffracted or otherwise misdirected by imperfections in the optics of the imaging system. In another example, photodiodes and other detector devices generally do not have 100% quantum efficiency. That is, these detector devices may not generate a signal each time a photon reaches the device. Therefore, even if an imaging system receives a sufficient number of photons for resolving two points according to the Rayleigh criterion, the non-ideal behavior of the detector device or medium further reduces the number of photons available to form an image. Accordingly, the actual resolution of most conventional optical imaging systems is generally worse than that predicted by the Rayleigh criterion.

As a result, the combination of the Rayleigh criteria and non-ideal behaviors of imaging systems have prevented significant miniaturization of imaging systems for providing high resolution images. Rather, conventional approaches have resulted in enlargement of imaging systems to resolve such issues. In particular, an increased size of optics is generally required to increase the effective aperture of the imaging system.

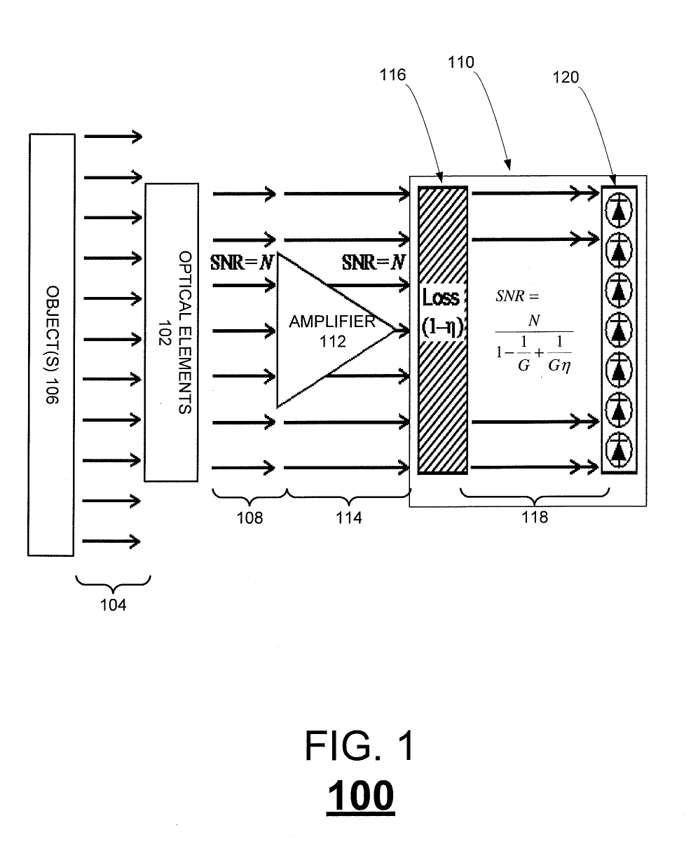

To overcome the limitations of such conventional imaging systems, embodiments of the invention provide systems and methods for improving actual resolution in imaging systems without the need to increase aperture sizing. In particular, the various embodiments of the invention provide an optical receiver including at least one photon counter device and an amplifier for enhancing operation of the photon counter device. In the various embodiments of the invention, an amplifier is provided to receive a signal photon beam and a pump photon beam. As used herein, a “photon beam” refers to a stream of photons propagating in substantially the same direction. The pump photon beam is used by the amplifier to increase the number of photons in the signal photon beam and therefore increase the number of photons delivered to the photon counter. In the various embodiments of the invention, the phase of the pump photons can be selected to substantially match the phase of the signal photons, thus introducing little or no noise or interference into the image. As a result, even if the quantum efficiency of the photon counter is relatively low, the increased number of signal photons overcomes, at least in part, the quantum inefficiencies of the photon counter. Thus, an improved image can be obtained from the limited number of photons received. This is conceptually described below with respect to FIG. 1.

As described above, an optical imaging system generally includes optical elements and one or more detector devices. In conventional operation, a number of photons are emitted or reflected from one or more objects. According to the Rayleigh criterion, only a portion of these photons pass through the optical elements, resulting in a beam of photons having a finite amount of photon noise. Photon noise, also known as photonic or photon shot noise, is a fundamental property of the quantum nature of light and simply represents the uncertainty in the optical signal. After passing through the optical elements, the portion of the photons passing through the optical elements then reaches the detector. The detector then uses these photons to generate an image. However, even if the optical elements operate ideally and all photons are successfully directed to the detector, non-ideal behavior of conventional detectors increases the signal to noise ratio (SNR) for the photons. In particular, a non-ideal detector can generally be modeled as an ideal detector being fed photons through a lossy (<100% transmittance) medium. As a result, the loss medium introduces a 1−η loss, where η is the transmittance of if the lossy medium. This provides the SNR expression:

SNR_{STD}(η)=η*N, (1)

where N is the SNR of the photons from the optical element. The reduced SNR thus results in corruption of the image. In particular, since the number of photons received is reduced, the ability to distinguish between objects or features is also reduced.

The losses in the non-ideal detector can be countered in the various embodiments of the invention by the inclusion of an amplifier that introduces little or no noise. This is shown in FIG. 1. FIG. 1 is a conceptual schematic of an imaging system 100 configured in accordance with an embodiment of the invention. As shown in FIG. 1, system 100 includes optical elements 102 for collecting photons 104 that are emitted or reflected by one or more objects 106. As described above, the Rayleigh criterion provides for only a portion 108 of the photons 104 passing through optical elements 102. The portion 108 can have an SNR of N, as described above.

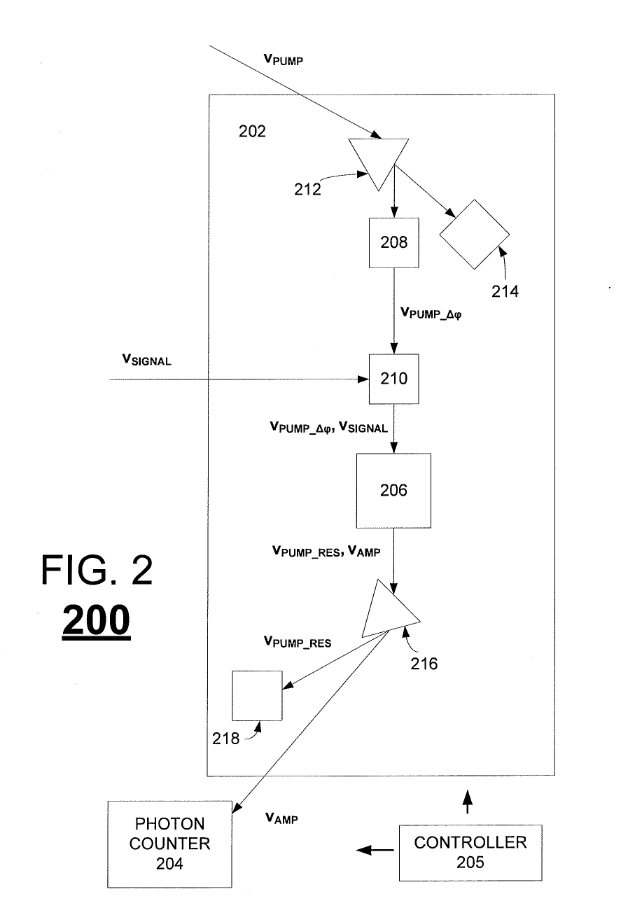

In the various embodiments of the invention, rather than directly passing the portion 108 of photons 104 to a detector 110, the portion 108 is first directed through an amplifier 112. The amplifier 112 is used to increase the energy of the portion 108 of photons 104 by increasing the number of photons to produce a beam of amplified photons 114. In the various embodiments of the invention, the amplifier 112 is configured so that an SNR of portion 108 and amplified photons 114 are substantially equal. A description of a noiseless amplifier will be described below in greater detail with respect to FIG. 2.

The beam of amplified photons 114 is then directed into non-ideal detector 110. As described above, non-ideal detector 110 (i.e., a detector with a quantum efficiency less than 100%) can be modeled as a lossy medium 116, with a loss 1−η, providing photons 118 to one or more ideal detectors 120. However, in the configuration of FIG. 1, the degradation of the SNR of photons 118 is not observed. In particular, a gain G is introduced by using amplifier 112. As a result, the SNR of the beam of photons provided to ideal detectors 120 is no longer scaled by as described above. Instead, by taking into account the increased energy of the photons (i.e., the increased number of photons) the SNR of photons 118 can instead be expressed as:

$${SNR}_{AMP} ( η ) = \frac{N}{1 - \frac{1}{G} + \frac{1}{G η}} \qquad ( 2 )$$

As a result, the SNR varies less severely with changes in η, such that SNR_{AMP}(η)>SNR_{STD}(η).

As described above, one aspect of the invention is to provide amplification in an optical receiver without the introduction of noise. In the various embodiments, this can be accomplished by amplifying photons emitted or reflected by one or more objects using an optical parametric amplifier (OPA). These photons are then pumped substantially in phase with the emitted or amplified photons. This is described below with respect to FIG. 2.

FIG. 2 is a schematic block diagram of an exemplary optical receiver 200, according to an embodiment of the invention. The configuration illustrated in FIG. 2 is presented by way of example and not by way of limitation. Accordingly, an optical receiver in accordance with the various embodiments of the invention can include more or less components than those shown in FIG. 2.

As shown in FIG. 2, receiver 200 includes an amplifier 202 and a photon counter 204. Receiver 200 can also include a controller 205 for adjusting or controlling various aspects of the operation of amplifier 202 and photon counter 204. Amplifier 202 can be configured to receive a pump photon beam (v_{PUMP}) and a signal photon beam (v_{SIGNAL}) of the photons emitted or reflected from one or more objects. Amplifier 202 is also configured to direct an amplified photon beam (v_{AMP}) to the photon counter 204. In amplifier 202, the amplified photons are produced using an OPA 206.

In some embodiments of the invention, the OPA 206 can comprise a crystal lacking inversion symmetry. In particular, the OPA 206 can comprise a non-linear crystal material exhibiting χ⁽²⁾ non-linearity. Crystal materials exhibiting χ⁽²⁾ non-linearity allow for frequency doubling, sum and difference frequency generation, and parametric amplification via non-linear frequency conversion. That is, photons can be converted to photons of another wavelength based on the non-linearity of the crystal material. In the case of parametric amplification, photons of a pump beam are converted into photons from an input beam. In the various embodiments of the invention, any type of χ⁽²⁾ non-linear crystal can be used for OPA 206, including, but not limited to, periodically-poled potassium titanyl phosphate (PPKTP), beta barium borate (BBO), potassium dihydrogen phosphate (KDP), potassium dideuterium phosphate (KD*P), ammonium dihydrogen phosphate (ADP), lithium niobate (LiNbO₃), and periodically-poled lithium niobate (PP LiNbO₃), and lithium triborate (LBO). Additionally, the crystal can be formed using a variety of processes to adjust its optical characteristics. For example, the crystal can be heated to adjust its phase matching characteristic.

Although any pump beam and input beam can be combined in a χ⁽²⁾ non-linear crystal to produce an amplified photon beam, the efficiency of the amplification is dependent on the difference in phase between the pump and input beams. Therefore, the closer the two beams are in phase, the higher the efficiency. Accordingly, in amplifier 202, a phase modulator 208 is provided to provide substantial matching between the phase of the pump photon beam and the signal photon beam in receiver 200. Although either the phase of the pump photon beam and/or the signal photon beam can be adjusted in the various embodiments of the invention, in the embodiment illustrated in FIG. 2, only the phase of the pump photon beam is adjusted by phase modulator 208. For example, as shown in FIG. 1, a phase adjusted pump photon beam (v_{PUMP}_{_{—}}_{Δφ}) is directed towards OPA 206 from phase modulator 208.

The phase of the pump photon beam can be adjusted in several ways. In some embodiments of the invention, the phase adjustment can be continuously or dynamically controlled via controller 205. For example, in one embodiment, the phase of the signal photon beam can be detected and the phase modulator 208 can use this information to adjust the phase of the pump photons. In another embodiment, the phase of the pump photon beam can be adjusted in response to the total energy of the amplified photons. In such embodiments, the phase can be adjusted so as to maximize the total output energy. For example, the phase of the pump photon beam can be adjusted by a controller 205 based on the number of photons being detected by photon counter 204. However, in some embodiments of the invention, the phase of the pump photon beam can be adjusted to a fixed value. In such embodiments, the phase of the pump photon beam can be set to an average expected value for the phase of the signal photon beam, base on the configuration of the imaging system. Although maximum efficiency may not be provided in such a configuration, if the phase is not expected to vary significantly for a particular configuration, the loss in efficiency due to lack of exact phase matching will not be significant. As a result, amplification of the signal photon beam can be provided with a minimal set of components. Particularly, without the need for additional sensors or complex control systems.

The types of components used for providing the phase modulation can also vary. For example, in some embodiments of the invention, phase modulator 208 can comprise an electro-optic modulator crystal, such as a Pockel cell, to adjust the phase of the pump photons by adjusting an electric field in the crystal. In other embodiments, phase modulator 208 can comprise an acousto-optic modulator crystal, such as a Bragg cell, to adjust the phase of the pump photons by inducing scattering in the crystal using sound waves. In such modulators, a piezoelectric transducer is attached to the crystal and an oscillating electric signal drives the transducer to vibrate, which creates sound waves in the crystal. In yet other embodiments, the phase modulator 208 can comprise a deformable mirror or waveguide. In such modulators, a piezoelectric transducer is attached to the mirror or waveguide and a voltage is applied to the piezoelectric transducer to cause deformation. The deformation can effect a phase shift by changing the path traversed by the optical beam, thus resulting in a change in refractive index and consequently a change in phase. However, the invention is not limited to the exemplary phase modulators listed above. Rather, any type of phase modulator can be used in the various embodiments of the invention. For example, a liquid crystal phase modulator can be used. The liquid crystal can be used to create a phase change via an increase (or decrease) in the index of refraction with an applied voltage.

In addition to having the phase of the pump photon beam substantially match the phase of the signal photon beam, a spatial alignment of the pump and signal photon beam can also be provided to improve efficiency in the OPA 206. Accordingly, a beam combiner element 210 can be provided to combine the phase adjusted photon beam from phase modulator 208 and the signal photon beam. In particular, the beam combiner element 210 spatially aligns the phase adjusted pump photon beam and the signal photon beam, at least substantially. For example, the phase adjusted pump photon beam and the signal photon beam can be directed through, for example, a prism, a diffraction grating, a dichroic mirror, or a volume Bragg grating, to produce a single beam. However, the invention is not limited to the exemplary beam combining components listed above. Rather, any type of beam combining components can be used in the various embodiments of the invention.

The combined beam of photons (ν_{PUMP}_{_{—}}_{Δφ}, ν_{SIGNAL}) is then directed through OPA 206, as described above. In a parametric amplification operation in a crystal exhibiting χ⁽²⁾ non-linearity, amplification occurs as follows. When a signal photon beam is directed through a crystal exhibiting χ⁽²⁾ non-linearity together with a spatially aligned pump beam of photons of a shorter wavelength, the interaction between the electromagnetic fields of the beams and the crystal causes photons of the pump wave to be converted into additional signal photons (i.e., photons of a same wavelength as the signal wave) and idler photons of third wavelength. As a result, the crystal outputs the original signal photons, the additional signal photons, idler photons, and residual pump photons. However, such a configuration is generally inefficient as the idler photons are not usable for imaging.

Accordingly, in the various embodiments of the invention, the pump photons are selected to have a wavelength that is ½ the wavelength of the signal photons. In such a configuration, the parametric amplification operates in a degenerate mode. In a degenerate mode of operation, the photons of the pump beam are still converted into additional signal photons and idler photons. However, the idler photons will have a same wavelength as the photons of the signal beam. Therefore, since the additional signal photons and idler photons are indistinguishable, this effectively results in a larger number of additional signal photons that can be used for imaging using photon counter 204.

In addition to the components described above, additional components can be provided to further reduce noise or interference. For example, a beam splitter 212 can be provided to remove any extraneous photons from the pump photon beam. For example, the pump photons can be directed through, for example, a prism, a diffraction grating, a dichroic mirror, or a volume Bragg grating, to direct only the pump photons to phase modulator 208. A beam stop 214 can be provided for terminating photons of other wavelengths. Similarly, a beam splitter 216 can be provided to separate the residual pump photons from the amplified photons prior to imaging using photon counter 204. For example, the output photon beam of OPA 206 can be directed through, for example, a prism, a diffraction grating, a dichroic mirror, or a volume Bragg grating, to direct only the amplified photons to photon counter 204. A beam stop 218 can be provided for terminating photons associated with the residual pump photons or photons of other wavelengths.

As shown in FIG. 2, imaging is performed using a photon counter 204. That is, the photodetector(s) in photon counter 204 are configured to detect the presence of at least a single photon. In some embodiments of the invention, a photodetector comprises a photomultiplier tube. With photomultiplier tubes, the quantum efficiency can reach several tens of percent in the visible spectral region, whereas devices for infrared light achieve quantum efficiencies of at most a few percent. In other embodiments of the invention, microchannel plate detectors can be used. However, the quantum efficiency of such devices is typically less than 50%.

In still other embodiments of the invention, avalanche photodiodes (APDs) can be operated in the Geiger mode for photon counting. In Geiger mode, the applied reverse voltage is kept slightly above the avalanche breakdown voltage. In such a configuration, an electron can then be triggered by a single photon. Depending on the wavelength, the quantum efficiency can be above 50% depending on the wavelength and the type of APD. In the various embodiments of the inventions, APDs can be fabricated from various types of semiconductor materials, including silicon (Si), indium gallium arsenide (InGaAs), indium phosphide (InP), or germanium (Ge). However, the various embodiments of the invention are not limited in this regard and any other materials can be used to form APDs.

The photon counter 204 can be configured in a variety of ways for forming images. For example, in one embodiment of the invention, photon counter 204 can comprise an array of photodetectors. In such a configuration, additional optic elements can be included in amplifier 202 or photon counter system for rastering the amplified photons across the photodetector array to form an image. In another embodiment one or a few photodetectors can be used without rastering. In such a configuration, signals generated by the photon counter 204 are associated with different pixels of an image based on a timing of scanning of objects used to generate the signal photons. However, the various embodiments of the invention are not limited to the exemplary embodiments described above and any other methods for generating images from the amplified photons can be used in the various embodiments of the invention.

As described above, an optical receiver in accordance with an embodiment of the invention can be used in various types of imaging systems. For example, in one embodiment of the invention, an optical receiver in accordance with an embodiment of the invention can be used to provide improved imaging of targets using laser detection and ranging (LADAR) systems and light detection and ranging (LIDAR) systems.

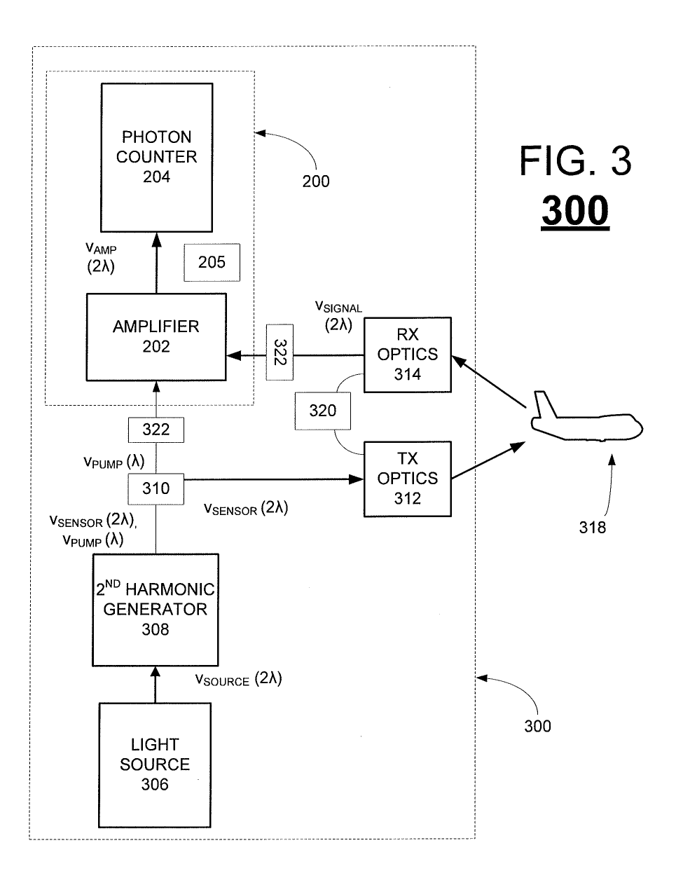

In general, LIDAR systems (typically used to image non-solid or diffuse targets such as aerosols, turbulent air, suspended particles, etc.) and LADAR systems (typically used to image solid targets or objects, such as vehicles, buildings, vegetation, terrain variations, etc.) use a high-energy laser, optical detector, and timing circuitry to determine the distance to a target. In a conventional system one or more laser pulses is used to illuminate a scene. Each pulse triggers a timing circuit that operates in conjunction with the detector array. In general, the system measures the time for each pixel of a pulse of light to transit a round-trip path from the laser to the target and back to the detector array. The reflected light from a target is detected in the detector array and its round-trip travel time is measured to determine the distance to a point on the target. The calculated range or distance information is obtained for a multitude of points comprising the target, thereby creating a 3D point cloud. The 3D point cloud can be used to render the 3-D shape of an object. In LADAR and LIDAR, images can be formed when the intensity at each point of the 3D point cloud is viewed. That is, for each point, the intensity of the return pulse of light (i.e., the number of reflected photons) will vary due to several factors. For example, the intensity can vary due to the amount of diffraction caused by the shape or composition of a surface or the amount of photons absorbed or reflected by a surface. An exemplary LIDAR/LADAR system is described below with respect to FIG. 3.

FIG. 3 is a schematic diagram of a LIDAR/LADAR system 300 configured in accordance with an embodiment of the invention. The configuration illustrated in FIG. 3 is presented by way of example and not by way of limitation. Accordingly, an optical receiver in accordance with the various embodiments of the invention can include more or less components than those shown in FIG. 3. Furthermore, the various embodiments of the invention are not limited to solely LADAR or LIDAR systems and can be used with any other types of imaging systems.

As shown in FIG. 3, system 300 can include an optical receiver 200 comprising an amplifier 202 and a photon counter system 202, as described above with respect to FIG. 2. System 300 can also include a light source 306, a second harmonic generator 308, a beamsplitter element 310, transmission (TX) optics 312, and receiving (RX) optics 314.

System 300 operates as follows. First, a source photon beam (v_{SOURCE}) is generated by a light source. This beam can be provided as a continuous or pulsed beam, depending on the imaging application. The photons of this source beam are configured to have a first wavelength 2λ. Although most optical imaging is conventionally performed using photons at wavelengths of visible light or near-infrared light, the various embodiments of the invention are not limited in this regard. Rather imaging can be performed in the various embodiments of the invention using any wavelength of light.

Once the source photon beam is generated by light source 306, this source photon beam can be directed to second harmonic generator 308 to generate photons associated with a second harmonic of the input photons (i.e., photons with 2× frequency, 2× energy, and ½ wavelength of input photons). As described above with respect to FIG. 2, one aspect of the invention is that the amplifier 202 provides parametric amplification in a degenerate mode. Therefore, the pump photon beam to be used in amplifier 202 should comprise a beam of photons at ½ the wavelength of the photons in the signal beam to be amplified. Accordingly, a second harmonic generator 308 is provided to convert a portion of the photons of the first wavelength 2λ in source photon beam into pump photons of a second wavelength λ. As a result, the second harmonic generator 308 effective outputs two photon beams, a pump photon beam with photons of a second wavelength λ and a sensor photon beam (v_{SENSOR}) comprising residual source photons of the first wavelength 2λ.

Although a pump photon beam having photons at a second wavelength λ could be separately generated, such a configuration would require and additional source of light. Furthermore, additional optical elements would be needed to substantially match the phase of the pump photons generated with the phase of source photons. In general the amount of such phase match would be significant, requiring a more complex phase modulator within amplifier 202 or additional phase modulators in system 300 prior to amplifier 202. However, by converting a portion of the photons in the source photon beam into pump photons and using the residual source photons to provide a signal photon beam for imaging, two photon beams substantially in phase are generated by second harmonic generator. As a result, the amount of phase modulation needed in amplifier 202 is relatively low, permitting the use of less complex phase modulator designs in amplifier 202.

In the various embodiments of the invention, any type of second harmonic generator can be used. For example, in some embodiments of the invention, second harmonic generator 308 can comprise an optical frequency doubler comprising a crystal lacking inversion symmetry. In particular, second harmonic generator 308 can comprise a non-linear crystal material exhibiting χ⁽²⁾ non-linearity. As described above, crystal materials exhibiting χ⁽²⁾ non-linearity allow for frequency doubling, sum and difference frequency generation, and parametric amplification via non-linear frequency conversion. That is, input photons are converted to photons of another wavelength based on the non-linearity of the crystal material. In the case of frequency doubling, a first photon beam is used to generate another photon with photons having twice the optical frequency (i.e., ½ the wavelength) of the photons of the input beam. In the various embodiments of the invention, any type of χ⁽²⁾ non-linear crystal can be used for the second harmonic generator, including, but not limited to, periodically-poled potassium titanyl phosphate (PPKTP), beta barium borate (BBO), potassium dihydrogen phosphate (KDP), potassium dideuterium phosphate (KD*P), ammonium dihydrogen phosphate (ADP), lithium niobate (LiNbO₃), and periodically-poled lithium niobate (PP LiNbO₃), and lithium triborate (LBO). However, the invention is not limited in this regard and any other method or systems frequency doubling can be used in the various embodiments of the invention.

The pump and sensor photon beams output by second harmonic generator 308 are then directed in system 300 into a beamsplitter element 310. As described above, the pump and sensor photon beams are output by second harmonic generator 308 as a single beam of photons. Accordingly, the beamsplitter element is used to direct the pump and second photon beams along different paths. In the various embodiments of the invention, any type of beamsplitter device can be used. For example, the output of second harmonic generator 308 can be directed through, for example, a prism, a diffraction grating, a dichroic mirror, or a volume Bragg grating, to direct the pump photon beam along a first path to optical receiver 200 and to direct sensor photon beam along a second path for performing imaging of one or more targets 318. As described above, the targets 318 can comprise solid or non-solid objects.

As described above, the sensor photon beam can be directed along a path to perform imaging of an target 318. In system 300, the sensor photon beam can be directed into the TX optics 312 and target 318 beyond. In the various embodiments of the invention, TX optics 312 can include any number of optical elements for the directing sensor photon beam to target 318. The optical elements can include mirrors, lenses, and filters, to name a few. However, the various embodiments of the invention are not limited in this regard and any other type of optical elements can be included. Additionally, TX optics 312 can include or be coupled to control system 320. The control system 320 can adjust the TX optics to scan with sensor photon beam a target area including target 318 in order to create an image. In some embodiments of the invention controller 320 can be coupled to a controller 205 of receiver 200 to coordinate operations of TX optics 312 with other components of system 300.

In system 300, imaging is based on the reflection of at least a portion of the sensor photons by target 318 and amplification of the signal photon beam comprising these photons. The reflected sensor photons (i.e., photons in the signal photon beam) are received by RX optics 314 and directed to optical receiver 200, particularly amplifier 202. In the various embodiments of the invention, RX optics 314 can also include any number of optical elements for collecting photons reflected by target 318. The optical elements can include mirrors, lenses, and filters, to name a few. However, the various embodiments of the invention are not limited in this regard and any other optical elements can be included. Additionally, RX optics 314 can also include or be coupled to control system 320 to synchronize operation of TX optics 312 and RX optics 314 during scanning of an area or with any other component of system 300.

As the signal photon beam is received by optical receiver 200, the pump photon beam is also received by optical receiver 200. In the various embodiments of the invention, system 300 can also include any number of additional optical elements 322 to couple the pump and signal photon beams into optical receiver 200, and in particular, amplifier 202. The optical elements 322 can include mirrors, lenses, and filters, to name a few. However, the various embodiments of the invention are not limited in this regard and any other optical elements can be included. Once the pump and signal photon beams are received by optical receiver, amplification of the signal photon beam to produce the amplified photon beam can be performed as described above with respect to FIG. 2.

It is worth noting that since the photons in the pump photon beam and the photons in the signal photon beam originate from the same beam, the source photon beam, these beams can generally remain close, if not matching, in phase. In such cases, since it is not expected that the interaction between the photons in the source photon beam and target 318 will significantly change the phase of the photons reflected back to system 300, the amount of phase modulation required in amplifier 202 is expected to be relatively low. However, in some cases the phase of photons from the object can be significantly from that of the photons in the source photon beam. Accordingly, the phase modulator 208 in amplifier 202 can be configured can sweep through different phases to provide a matching phase between the source photon beam and the photons returning from the object prior to combining them in OPA 206. Accordingly, as described above, complex phase modulation is generally unnecessary in LADAR and LIDAR systems. As a result, this permits an average amount of phase modulation (to principally account for phase changes due to optics) can be provided without significant affecting image quality.

### EXAMPLES

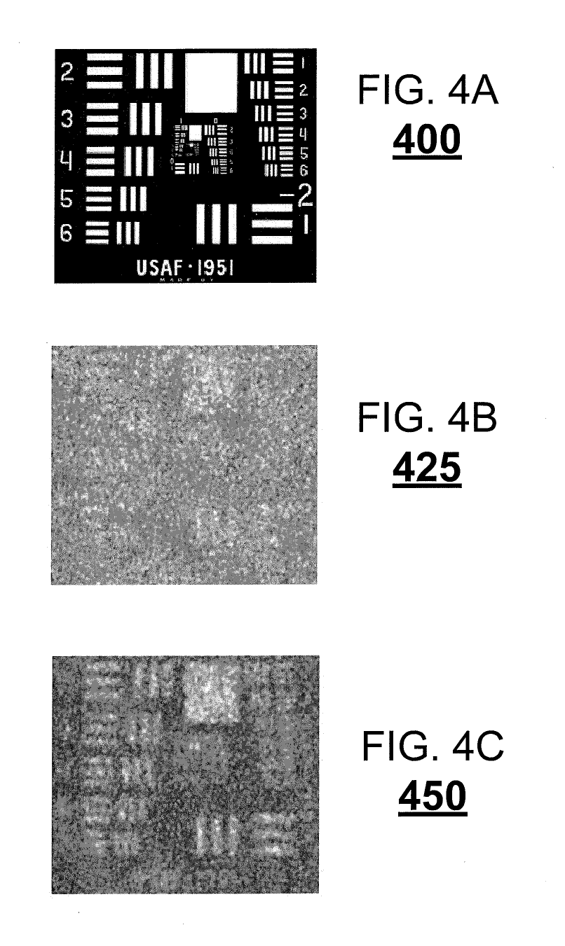

The following non-limiting Examples serve to illustrate selected embodiments of the invention. It will be appreciated that variations in proportions and alternatives in elements of the components shown will be apparent to those skilled in the art and are within the scope of embodiments of the present invention. MATLAB® simulations were used to establish the subjective imaging benefits afforded by phase sensitive amplification when viewing a speckle-limited USAF test target pattern. The simulations confirm the resolution predictions found for the point-target hypothesis testing problem. FIGS. 4A, B, and C depict 100-frame-averaged images (i.e., each image is averaged over 100 independent speckle shots) from simulations both taken at −3.3 dB single-frame SNR and with standard homodyne detection.

FIG. 4A is an image 400 representing the result of capturing an image of the scene in image 400 using an imaging system including detectors modeled as having 100% quantum efficiency (i.e., modeled as comprising ideal detectors). In image 400, all the photons associated with the scene in image 400 are detected and objects in the scene are readily discernable. For example, the portions of image 400 associated with the target bars in the scene can be easily distinguished from the portions of image 400 associated with the background.

FIG. 4B is an image 425 of a simulated result of capturing an image of the scene in image 400 using an imaging system including detectors are modeled as having less than 100% quantum efficiency. In the simulation, the detectors were modeled as including a lumped loss from the lossy medium such that the detector efficiency and associated transmittance result in a 25% quantum efficiency. Consequently, only a portion of the photons associated with the scene in image 400 are detected. The resulting loss of photons results in corruption of the image, particularly due to the reduction of SNR, as described above. As a result, objects in the scene are not easily discernable in image 425. For example, the portions of image 425 associated with the smaller target bars in the scene cannot be easily distinguished from the portions of image 425 associated with the background. Accordingly, the value of such images is limited.

FIG. 4C is an image 450 of a simulated result of capturing an image of the scene in image 400 using an imaging system including detectors are modeled as having less than 100% quantum efficiency, but also including an amplifier in accordance with an embodiment of the invention. In the simulation, the detectors were modeled as including a lumped loss from the lossy medium such that the detector efficiency and associated transmittance result in a 25% quantum efficiency, similar to the modeling for generating FIG. 4B. However, the imaging system is also modeled to include amplification of a input beam (i.e. to increase in the number of photons associated with the scene in image 400.) For purposes of simulation, the amplification was modeled to provide a gain of 10 dB. Since the detectors are still modeled as having less than 100% quantum efficiency, only a portion of the photons associated with the scene in image 400 are detected. However, since the modeled amplifier effectively increases the number of photons prior to detection, the effective number of photons lost is reduced. Consequently the amount of corruption of the image is also reduced, particularly due to the less severe reduction of the SNR. Since some level of corruption is still present, objects in the scene are not as easily discernable in image 450 as in image 400. However, the increased number of photons detected results in more features of the scene being distinguishable in image 450 as compared to image 425. For example, the portions of image 450 associated with the smaller target bars in the scene can now be more easily distinguished from the portions of image 450 associated with the background. Accordingly, the simulated results show that image collection can be substantially improved via the addition of an amplifier in accordance with an embodiment of the invention.

Applicants present certain theoretical aspects above that are believed to be accurate that appear to explain observations made regarding embodiments of the invention. However, embodiments of the invention may be practiced without the theoretical aspects presented. Moreover, the theoretical aspects are presented with the understanding that Applicants do not seek to be bound by the theory presented.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. An imaging system, comprising:
a second harmonic generator for receiving a source photon beam of a first wavelength and generating a sensor photon beam of said first wavelength and a pump photon beam of a second wavelength that is one half of said first wavelength;
an amplifier configured to receive a signal photon beam containing a number of photons and said pump photon beams and produce an amplified photon beam of said first wavelength containing a number of photons, the number of photons in said amplified photon beam being greater the number of photons in said signal photon beam, and said signal photon beam comprising a portion of said sensor photon beam reflected from a target; and
at least one photon counter configured to receive and detect at least a portion of said photons in said amplified photon beam.

2. The system of claim 1, wherein said second harmonic generator comprises a crystal having χ⁽²⁾ nonlinearity.

3. The system of claim 1, wherein said second harmonic generator comprises a crystal comprising one of lithium niobate, potassium titanyl phosphate, and lithium triborate.

4. The system of claim 1, wherein said amplifier comprises a crystal having χ⁽²⁾ nonlinearity.

5. The system of claim 1, wherein said amplifier comprises a crystal comprising one of lithium niobate, potassium titanyl phosphate, and lithium triborate.

6. The system of claim 1, further comprising at least one phase modulator directing said pump photon beam into said amplifier, said phase modulator configured to adjust a phase of said pump photon beam to substantially match a phase of said signal photon beam.

7. The system of claim 6, wherein said phase modulator comprises a piezo-driven deformable mirror.

8. The system of claim 1, further comprises at least one beamsplitter element spatially aligning said pump photon beam and said signal photon beam and directing said pump photon beam and said signal photon beam into said amplifier.

9. The system of claim 1, wherein said photon counter comprises one of an avalanche photodiode operating in a Geiger mode, a photomultiplier tube, and a microchannel plate detector.

10. An optical receiver, comprising:
at least one phase modulator configured to receive a pump photon beam comprising photons of a first wavelength to adjust a phase of said pump photon beam to substantially match a phase of a signal photon beam reflected by a target and containing a number of photons of a second wavelength that is twice said first wavelength;
at least one beam combiner element for generating a combined photon beam using said pump photon beam from said phase modulator and said signal photon beam;
an amplifier configured for producing an amplified photon beam containing a number of photons of said second wavelength based on said combined photon beam, the number of photons in said amplified photon beam greater than the number of photons in said signal photon beam; and
at least one photon counter configured to receive and detect at least a portion of said photons in said amplified photon beam.

11. The optical receiver of claim 10, wherein said amplifier comprises a crystal having χ⁽²⁾ nonlinearity.

12. The optical receiver of claim 10, wherein said amplifier comprises a crystal comprising one of lithium niobate, potassium titanyl phosphate, and lithium triborate.

13. The optical receiver of claim 10, wherein said phase modulator comprises a piezo-driven deformable mirror.

14. The optical receiver of claim 10, wherein said beam combiner element comprises a dichroic mirror.

15. The optical receiver of claim 10, wherein said photon counter comprises one of an avalanche photodiode operating in a Geiger mode, a photomultiplier tube, and a microchannel plate detector.

16. A imaging method, comprising:
providing a source photon beam comprising photons of a first wavelength to a second harmonic generator to obtain a sensor photon beam comprising photons of said first wavelength and a pump photon beam comprising photons of a second wavelength that is one half of said first wavelength;
directing said sensor photon beam towards at least one target;
collecting a signal photon beam containing a number of photons comprising at least a portion of said sensor photon beam reflected by said target;
generating an amplified photon beam containing a number of photons of said first wavelength using an amplifier, said pump photon beam, and said signal photon beam, the number of photons in said amplified photon beam being greater the number of photons in said signal photon beam; and
detecting at least a portion of said photons in said amplified using at least one photon counter to form at least one image.

17. The method of claim 16, wherein said providing further comprises selecting said second harmonic generator to comprise a crystal having χ⁽²⁾ nonlinearity.

18. The method of claim 16, wherein said generating further comprises selecting said amplifier to comprise a crystal having χ⁽²⁾ nonlinearity.

19. The method of claim 16, further comprising:
prior to said generating, adjusting a phase of said pump photon beam to substantially match a phase of said signal photon beam.

20. The method of claim 16, further comprising:
prior to said generating, spatially aligning said pump photon beam and said signal photon beam.

21. The method of claim 16, wherein detecting further comprises selecting said photon counter to comprise one of an avalanche photodiode operating in a Geiger mode, a photomultiplier tube, and a microchannel plate detector.
